(19) United States
(12) Patent Application Publication
(10) Pub. No.: US 2008/0192032 A1
(43) Pub. Date: Aug. 14, 2008

(54) DISPLAY APPARATUS AND METHOD OF DRIVING THE SAME

(75) Inventors: Moon Chul Park, Seoul (KR); Yeong Koo Kim, Seoul (KR); Hisashi Kimura, Suwon-si (KR); Chang Jin Im, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/933,146

(22) Filed: Oct. 31, 2007

(30) Foreign Application Priority Data
Jan. 19, 2007 (KR) 10-2007-0006213

(51) Int. Cl. G09G 5/00

(52) U.S. Cl. 345/204

(57) ABSTRACT

A display apparatus and a method of driving the same that can prevent erroneous operation by compensating for the delay of a gate turn-on signal. A signal detector generates a delay control signal according to an internal clock signal and the gate turn-on signal. The signal detector detects whether the gate turn-on signal applied to the gate line is delayed or not, and the pulse width of a logic high period of the clock signal is controlled according to the detection result, such that it is possible to compensate for the delay of the gate turn-on signal.

### CROSS REFERENCE TO RELATED APPLICATION

This application claims priority to Korean Patent Application No. 10-2007-0006213 filed on Jan. 19, 2007, in the Korean Intellectual Property Office, the disclosure of which is incorporated herein by reference in its entirety.

### BACKGROUND OF THE INVENTION

1. Field of the Invention

The invention relates to a display apparatus and, more particularly, to a display apparatus and a method of driving the same that are capable of preventing a temperature-induced delay of gate turn-on voltages.

2. Description of the Related Art

In a display apparatus having gate and data drivers, gate turn-on signals are sequentially applied to a plurality of gate lines and gray signals are applied to a plurality of data lines to display images. In general, the gate driver is manufactured in the form of an IC chip and is mounted on a peripheral area of the manufactured display panel and connected to the gate lines of the display panel.

In the related art, a poor connection between the gate driver and the gate lines sometimes occurs. Further, since the gate driver is separately manufactured in the form of the IC chip, manufacturing costs of the display apparatus increase. More recently, the display panel and the gate driver have been manufactured at the same time, with the gate driver being constructed in an edge area at one side of the display panel, thereby reducing manufacturing cost and preventing poor connections between the gate driver and the gate lines. When the gate driver and the display panel are manufactured at the same time, the circuit element that forms the gate driver is manufactured using amorphous silicon which has the effect of greatly changing the mobility of electrons in response to changes in the ambient temperature. When the peripheral temperature is lowered, the response speed of the circuit element formed of amorphous silicon rapidly decreases.

In general, the gate driver supplies gate turn-on signals in the form of a single pulse to the gate lines during the gate turn-on period. However, when the circuit element of the gate driver is formed of amorphous silicon, the gate turn-on signal output by the gate driver is delayed according to the ambient temperature. When the peripheral temperature of the display panel is lowered, the rising edge region and the falling edge region of the gate turn-on signal are delayed, thereby distorting the gate turn-on signal. Delay of the falling edge region is delayed causes the gate turn-on signal to be output during a different period from the gate turn-on period, which results in malfunction of the display panel.

### SUMMARY OF THE INVENTION

According to one aspect of an exemplary embodiment, a display apparatus and a method of driving the same prevent distortion that occurs due to a delay of a gate turn-on signal by providing a delay compensator. If the gate turn-on signal is delayed, a delay compensating signal is provided to control the cycle of the gate turn-on signal.

According to an aspect of the invention, a display apparatus includes a display panel that includes a plurality of gate lines connected to a plurality of pixels, a gate driver that sequentially supplies gate turn-on signals to the plurality of gate lines according to a driving clock signal, a gate clock generator that generates the driving clock signal according to an internal clock signal and a delay control signal, and a signal detector that generates the delay control signal according to the internal clock signal and the gate turn-on signal.

The width of the logic high period of the internal clock signal may be one horizontal clock cycle 1H. The pulse width of the delay control signal may be the same as a delay width of the gate turn-on signal following the one horizontal clock cycle 1H.

The gate clock generator may reduce the width of the logic high period of the driving clock signal by the pulse width of the delay control signal.

The gate clock generator changes the width of the logic high period of the driving clock signal according to the delay control signal supplied during a previous frame period and supplies the driving clock signal, having a logic high period of changed width, to the gate driver during the current frame period. The signal detector may further generate a reset signal that resets the operation of the gate clock generator that changes the width of the logic high period of the driving clock signal. The signal detector may generate the delay control signal according to a gate turn-on signal that is supplied to the first gate line, and the reset signal according to a gate turn-on signal that is supplied to the final gate line.

The signal detector may include a signal converter that outputs a converting signal according to at least one gate turn-on signal, which are applied to the plurality of gate lines, respectively, and a signal inspecting unit that compares the internal clock signal with the converting signal so as to output a delay control signal.

The signal converting unit may include a first driving transistor that has an emitter terminal connected to a direct current signal input terminal and a collector terminal connected to a converting signal output terminal, a first resistor provided between a base terminal of the first driving transistor and the direct current signal input terminal, a second resistor having one end connected to the base terminal of the first driving transistor, a second driving transistor having an emitter terminal connected to ground and a collector terminal connected to the second resistor, a third resistor connected between a base terminal of the second driving transistor and ground, a fourth resistor connected between the base terminal of the second driving transistor and the gate turn-on signal input terminal, and a fifth resistor connected between the collector terminal of the first driving transistor and ground.

The signal inspecting unit may include a logical product signal generating unit that generates a logical product signal by performing a logical product of the converting signal and the internal clock signal, and a delay control signal generating unit that generates a delay control signal by performing an exclusive logical sum of the logical product signal and the converting signal. An AND gate may be used as the logical product signal generating unit and an exclusive OR gate may be used as the delay control signal generating unit.

The converting signal may have the same cycle but different amplitude from the gate turn-on signal.

The peak amplitude of the logic high period of the gate turn-on signal may be in a range of 5 to 30 V, and the peak amplitude of the logic high period of the converting signal may be in a range of 1 to 5 V.

The display panel may include a lower substrate that has a plurality of gate lines extending in one direction and an upper substrate that is disposed on the lower substrate, and the gate driver may be formed at the edge of one side of the lower substrate and include a plurality of stages connected to the plurality of gate lines, respectively.

The display panel may include a lower substrate that has a plurality of gate lines extending in one direction and an upper substrate that is disposed on the lower substrate, and the gate driver may include first and second gate drivers that are formed at the edge of both sides of the lower substrate while the first gate driver is connected to odd-numbered gate lines and the second gate driver is connected to even-numbered gate lines.

The internal clock signal may be generated using a dot clock signal that has a higher frequency than the internal clock signal, and the gate clock generator may detect the pulse width of the delay control signal by using the dot clock signal.

The driving clock signal may include a gate clock signal and an inverted gate clock signal.

According to another aspect of the invention, a method of driving a display apparatus includes generating a driving clock signal by using an internal clock signal, generating gate turn-on signals according to the driving clock signal, supplying the gate turn-on signals to gate lines, generating a delay control signal that has a pulse width as wide as the delay width of the gate turn-on signal after the gate turn-on signal is delayed, and reducing the pulse width of a logic high period of the driving clock signal as much as the pulse width of the delay control signal.

The generating of the delay control signal may include generating a converting signal that has the same cycle as the gate turn-on signal and the low voltage level of the peak amplitude, generating a logical product signal by performing a logical product of the converting signal and the internal clock signal, and generating the delay control signal by performing an exclusive logical sum of the logical product signal and the converting signal.

### BRIEF DESCRIPTION OF THE DRAWINGS

FIG. 1 is a block diagram illustrating a display apparatus according to a first embodiment of the present invention;

FIG. 2 is a waveform diagram illustrating the operation of the display apparatus according to the first embodiment;

FIG. 3 is a block diagram illustrating the display apparatus according to the first embodiment;

FIG. 4 is a circuit diagram illustrating stages according to the first embodiment;

FIG. 5 is a waveform diagram illustrating the operation of a gate driver according to the first embodiment;

FIG. 6 is a circuit diagram illustrating a signal detector according to the first embodiment;

FIG. 7 is a waveform diagram illustrating the operation of the signal detector according to the first embodiment;

FIG. 8 is a block diagram illustrating a display apparatus according to a second embodiment;

FIG. 9 is a circuit diagram illustrating a signal detector according to the second embodiment;

FIG. 10 is a waveform diagram illustrating the operation of the display apparatus according to the second embodiment; and

FIG. 11 is a block diagram illustrating a display apparatus according to a third embodiment.

### DESCRIPTION OF THE PREFERRED EMBODIMENTS

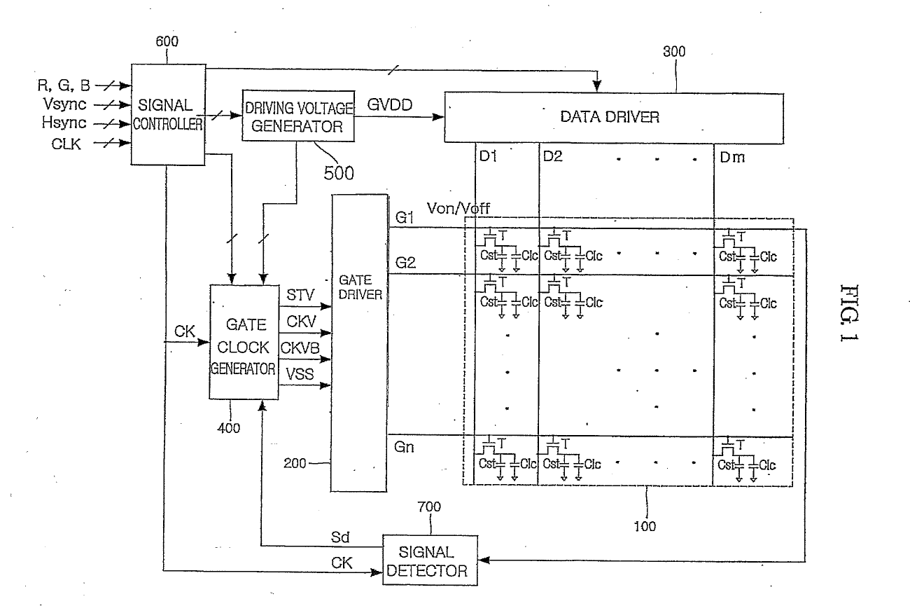

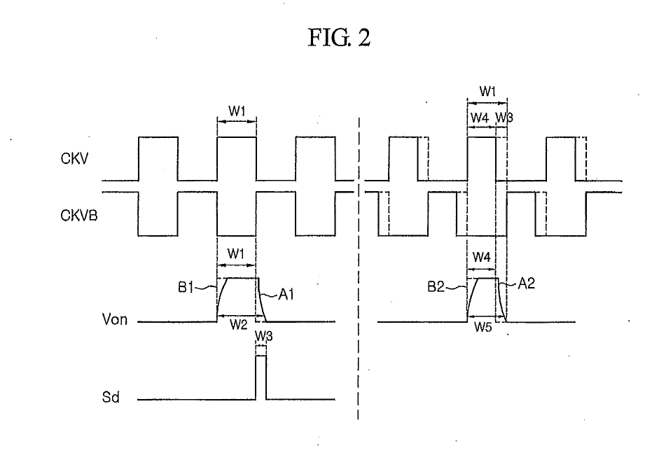

Hereinafter, embodiments of the invention will be described in detail with reference to the accompanying drawings. FIG. 1 is a block diagram illustrating a display apparatus according to a first embodiment of the present invention. FIG. 2 is a waveform diagram illustrating the operation of the display apparatus according to the first embodiment of the present invention.

Referring to FIGS. 1 and 2, the display apparatus according to this embodiment includes a display panel 100, a gate driver 200, a data driver 300, a gate clock generator 400, a driving voltage generator 500, a signal controller 600, and a signal detector 700.

The display panel 100 includes a plurality of gate lines G1 to Gn that extend in a first direction and a plurality of data lines D1 to Dm that extend in a second direction crossing the first direction. The display panel 100 includes unit pixels that are formed at intersections between the gate lines G1 to Gn and the data lines D1 to Dm. Each of the unit pixels includes a thin film transistor T, a storage capacitor Cst, and a pixel capacitor Clc.

The display panel 100 includes a lower substrate (not shown), an upper substrate (not shown), and liquid crystal (not shown). The lower substrate includes the thin film transistors T, the gate lines G1 to Gn, the data lines D1 to Dm, pixel electrodes for the pixel capacitors Clc and the storage capacitors Cst, and storage electrodes for the storage capacitors Cst. The upper substrate includes a black matrix, color filters, and a common electrode for the pixel capacitors Clc. The liquid crystal is interposed between the upper substrate and the lower substrate.

Gate terminals of the thin film transistors T are connected to the gate lines G1 to Gn, and source terminals thereof are connected to data lines D1 to Dm. The drain terminals are connected to the pixel electrodes. The thin film transistors T having the above-described structure operate according to gate-turn on signals that are applied to the gate lines. The thin film transistors supply data signals (i.e., gray signals) from the data lines D1 to Dm to the pixel electrodes so as to change the electric field within the pixel capacitors Clc. The alignment of the liquid crystal in the display panel 100 is changed such that the transmissivity of light, which is supplied from a backlight, can be controlled.

As a domain controlling unit that adjusts the direction in which the liquid crystal is aligned, a plurality of cutouts and/or protrusion patterns may be provided on the pixel electrode, and protrusions and/or cutout patterns may be provided on the common electrode. Preferably, the liquid crystal according to this embodiment is aligned in a vertically aligned mode.

Controllers that supply signals so as to drive the display panel 100 are provided outside the display panel 100 having the above-described structure. The controllers include the gate driver 200, the data driver 300, the gate clock generator 400, the driving voltage generator 500, the signal controller 600, and the signal detector 700.

The signal controller 600 receives image signals R, G, and B from an external graphic controller (not shown), and external control signals including a vertical synchronization signal Vsync, a horizontal synchronization signal Hsync, and an external clock signal CLK, which are frame identification signals. Signal controller 600 generates and outputs control signals that control the operation of the gate driver 200 and the data driver 300.

The driving voltage generator 500 generates various driving voltages, which are required to drive the display apparatus, by using a voltage control signal of the signal controller 600 and/or an external power supply voltage. The driving voltage generator 500 generates a reference voltage GVDD, a gate turn-on voltage, a gate turn-off voltage, and a common voltage. The driving voltage generator 500 applies the gate turn-on voltage and the gate turn-off voltage to the gate clock generator 400, and the reference voltage GVDD to the data driver 300 according to the control signal of the signal controller 600. The reference voltage GVDD is used as a basic voltage that is used to generate a gray voltage so as to drive the liquid crystal.

The data driver 300 uses a data control signal and a pixel data signal of the signal controller 600 and the reference voltage GVDD of the driving voltage generator 500 to generate gray signals and apply the gray signals to the data lines D1 to Dm, respectively. That is, the data driver 300 converts the pixel data signal in a digital format, which is driven and input according to the data control signal, into gray signals in an analog format by using the reference voltage GVDD. Further, the data driver 300 correspondingly supplies the converted gray data signals to the plurality of data lines D1 to Dm.

The gate clock generator 400 generates a vertical synchronization start signal STV and a driving clock signal according to an internal clock signal CK and the control signals of the signal controller 600, the gate turn-on voltage and the gate turn-off voltage of the driving voltage generator 500, and a delay control signal Sd of the signal detector 700. The gate clock generator 400 supplies the generated vertical synchronization start signal STV and driving clock signal to the gate driver 200. Here, the driving clock signal includes a gate clock signal CKV and/or an inverted gate clock signal CKVB. Hereinafter, a description will be made of a case in which both the gate clock signal CKV and the inverted gate clock signal CKVB are used as the driving clock signal.

The gate clock generator 400 generates the gate clock signal CKV and the inverted gate clock signal CKVB according to the internal clock signal CK and the delay control signal Sd. The width (i.e., cycle) of a logic high period of each of the gate clock signal CKV and the inverted gate clock signal CKVB is changed according the delay control signal. The gate clock signal CKV and the inverted gate clock signal CKVB have voltage levels corresponding to the gate turn-on voltage and the gate turn-off voltage. That is, a logic high state of each of the gate clock signal CKV and the inverted gate clock signal CKVB has a voltage level corresponding to that of the gate turn-on voltage, and a logic low state of each of the gate clock signal CKV and the inverted gate clock signal CKVB has a voltage level corresponding to that of the gate turn-off voltage. Preferably, the voltage level of the gate turn-on voltage is in the range of 5 to 30 V, and the voltage level of the gate turn-off voltage is in the range of −5 to −30 V. Preferably, the logic level of each of the internal clock signal CK, the control signals, and the delay control signal Sd has a voltage level that is used in a general logic chip. That is, the voltage of each of the signals in the logic high state is in the range of 1 to 5 V, and a voltage of each of the signals in the logic low state is in the range of −1 to 1 V.

The gate clock generator 400 supplies the ground voltage VSS to the gate driver 200. However, the present invention is not limited thereto, and the ground voltage may be directly transmitted from the driving voltage generator 500 to the gate driver 200. Further, the vertical synchronization start signal STV may be directly transmitted from the signal controller 600 to the gate driver 200.

The gate driver 200 applies the gate turn-on signals Von and the gate turn-off signals Voff to the gate lines G1 to Gn according to the vertical synchronization start signal STV, the gate clock signal CKV, and the inverted gate clock signal CKVB. The gate turn-on signals Von are sequentially supplied to the plurality of gate lines G1 to Gn. The gate turn-on signals Von are signals in the form of a single pulse. When the gate turn-on signals Von are not delayed, it is preferable that the gate turn-on signals Von be supplied to the gate lines G1 to Gn for one horizontal clock cycle 1H. The gate turn-on signals Von are preferably supplied to the gate lines G1 to Gn during the logic high period of the gate clock signal CKV or the inverted gate clock signal CKVB. Accordingly, the thin film transistors T connected to the gate lines G1 to Gn are turned on to thereby display an image.

The signal detector 700 generates the delay control signal Sd according to the gate turn-on signal Von and the internal clock signal CK. The signal detector 700 detects the delay width of the gate turn-on signal Von by comparing the widths of the logic high periods of the gate turn-on signal Von, which is an output of the gate driver 200, and the internal clock signal CK. The signal detector 700 supplies the delay control signal Sd corresponding to the delay width of the gate turn-on signal Von to the gate clock generator 400, such that the widths of the logic high periods of the gate clock signal CKV and the inverted gate clock signal CKVB are controlled. Therefore, the width (i.e., cycle) of the delayed gate turn-on signal Von is controlled such that the delay of the gate turn-on signal Von can be compensated.

The operation of the display apparatus according to this embodiment will now be described with reference to FIG. 2.

The gate driver 200 receives the gate clock signal CKV and the inverted gate clock signal CKVB of the gate clock generator 400. The gate driver 200 uses the gate clock signal CKV and the inverted gate clock signal CKVB to supply the gate turn-on signals Von to the gate lines G1 to Gn. As shown by a dashed line B1 of FIG. 2, it is preferable that the gate turn-on signals Von are supplied to the gate lines G1 to Gn, respectively, during a logic high period W1 of the gate clock signal CKV (or inverted gate clock signal CKVB). As such, when the gate turn-on signal Von is not delayed, the width W1 of the gate clock signal CKV in a logic high state (i.e., logic high period) becomes one horizontal clock cycle 1H.

As described in the related art, when an element formed of amorphous silicon is used as a circuit element of the gate driver 200, the response speed of the gate driver 200 is remarkably changed according to external environment (e.g., ambient temperature). The gate-turn-on signal Von, which is the output of the gate driver 200, is delayed, as shown by a solid line A1 in FIG. 2, which causes the width of the gate turn-on signal Von to be increased. That is, the gate driver 200 outputs the gate turn-on signal Von whose width W2 is larger than the width W1 corresponding to the logic high period of the gate clock signal CKV. This is caused by a signal delay by circuit elements in the gate driver 200. When the logic state of the gate turn-on signal Von is changed, the change is not immediately made but delayed. In particular, as shown by the solid line A1 of FIG. 2, when the gate turn-on signal Von changes from the logic high level to the logic low level, the change in state is delayed, and the width W2 of the logic high period of each of the gate turn-on signals Von supplied to the gate lines G1 to Gn is increased. Therefore, the turn-on time of the thin film transistors T connected to the gate lines G1 to Gn becomes longer (than the one horizontal clock cycle 1H), and an undesired gray signal may be supplied to the pixel capacitor Clc through the turned-on thin film transistor T. As a result, an inappropriate image may be displayed.

The signal detector 700 according to this embodiment compares the width W2 of the logic high period of the delayed gate turn-on signal Von with the width of the logic high period of the internal clock signal Ck of the signal controller 600 so as to generate the delay control signal Sd having a width W3 corresponding to the delayed width of the gate turn-on signal Von. The width of the logic high period of the internal clock signal Ck is the same as one horizontal clock cycle 1H (width W1 of the gate clock signal CKV in a logic high state when the gate turn-on signal Von is not delayed). The signal detector 700 supplies the delay control signal Sd to the gate clock generator 400. The gate clock generator 400 supplies a new gate clock signal CKV and a new inverted gate clock signal CKVB, each of which has the changed width of the logic high period, to the gate driver 200 according to the delay control signal Sd. Preferably, each of the gate clock signal CKV and the inverted gate clock signal CKVB, each of which has the changed width (i.e., cycle), has a width W4 that is obtained by subtracting the width W3 of the delay control signal Sd from the width W1 of the previous (initial) gate clock signal CKV and the inverted gate clock signal CKVB.

According to the new gate clock signal CKV and the new inverted gate clock signal CKVB, each of which the changed width W4 of the logic high period thereof, the gate driver 200 supplies the gate turn-on signals Von to the gate lines G1 to Gn. At this time, as described above, due to the external environment, the gate turn-on signal Von, which is the output of the gate driver 200, may not have the width W4 corresponding to the logic high period of the gate clock signal CKV as shown by a dashed line B2 of FIG. 2. Thus, the gate turn-on signal Von is delayed and has a width W5 larger than the width W4 as shown by a solid line A2 of FIG. 2. The width W5 of the new gate turn-on signal Von that is delayed and output by the gate driver 200 becomes a value that is similar to the one horizontal clock cycle 1H. This is because the width of the signal delayed by the gate driver 200 is the same as that of the delay control signal Sd. That is, the gate turn-on signal Von is delayed as long as the period (W3) that is cut off from the gate clock signal CKV and the inverted gate clock signal CKVB. Therefore, in this embodiment, the signal delay by the gate driver 200 is detected by the signal detector 700, and according to the detection result, a logic high period of each of the clock signals that is applied to the gate driver 200 is changed (i.e., a duty ratio of the clock signal is controlled), such that the gate turn-on signals Von can be supplied to the gate lines for one horizontal clock cycle 1H.

At this time, the width W5 of the new gate turn-on signal Von may be smaller than the one horizontal clock cycle 1H. In this case, since the turn-on time of the thin film transistor T is reduced, the pixel capacitor Clc may not be sufficiently charged with a gray signal. Therefore, in order to solve this problem, the amplitude of the gray level, which is the output of the data driver 300, may be increased.

In FIG. 1, the delay control signal Sd is supplied to the gate clock generator 400. However, the present invention is not limited thereto, and the delay control signal Sd may be supplied to the signal controller 600 such that the width of the logic high level of each of the gate clock signal CKV and the inverted gate clock signal CKVB may be controlled. The gate clock generator 400 and the signal controller 600 may be provided in a single driving control unit. That is, the driving control unit may generate an internal clock CK, and generate or change a gate clock signal CKV and an inverted gate clock signal CKVB according to the internal clock CK and the delay control signal Sd.

The internal clock signal CK that is applied to the gate clock generator 400 may be generated according to a dot clock signal (i.e., a clock signal having a higher frequency than the internal clock signal CK). For example, by using a dot clock signal having one hundred cycles, an internal clock signal having one cycle can be generated. At this time, the gate clock generator 400 uses the dot clock signal so as to detect the pulse width of the delay control signal Sd. For example, when the width of the delay control signal Sd corresponds to one tenth of one cycle of the internal clock signal CK, the width of the delay control signal Sd may be the same as that of ten cycles of dot clock signals. As such, it is possible to accurately calculate the pulse width of the delay control signal Sd. Therefore, using the delay control signal Sd whose pulse width is accurately calculated, the gate clock generator 400 can reduce the width of the logic high period of each of the gate clock signal CKV and the inverted gate clock signal CKVB by the calculated pulse width, and output the gate clock signal CKV and the inverted gate clock signal CKVB, each of which has the reduced width.

The signal controller 600, the data driver 300, the gate clock generator 400, and the signal detector 700 are manufactured in the form of a chip, and mounted onto a printed circuit board (PCB). Further, preferably, the signal controller 600, the data driver 300, the gate clock generator 400, and the signal detector 700, which are mounted onto the printed circuit board, are electrically connected to the display panel 100 through a flexible printed circuit board (FPCB). However, the present invention is not limited thereto, and the data driver 300 and the signal detector 700 may be mounted onto the lower substrate of the display panel 100. Preferably, the gate driver 200 according to this embodiment is provided at the edge of one side of the lower substrate of the display panel 100. At this time, the gate driver 200 includes a plurality of stages 200-1 to 200-n.

Hereinafter, the gate driver having a plurality of stages according to this embodiment will be described with reference to the accompanying drawings.

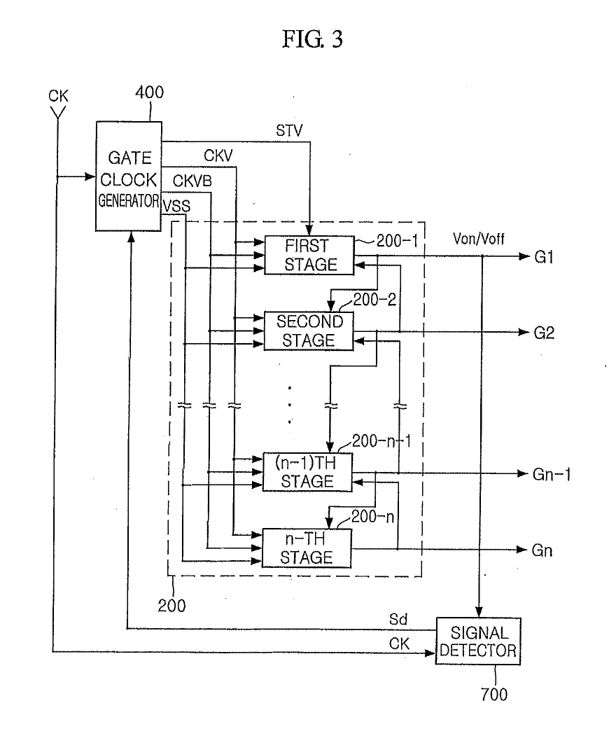

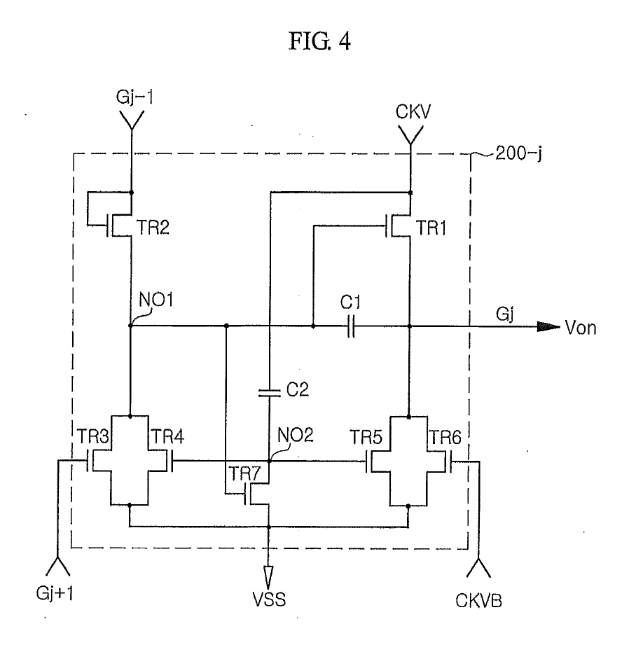

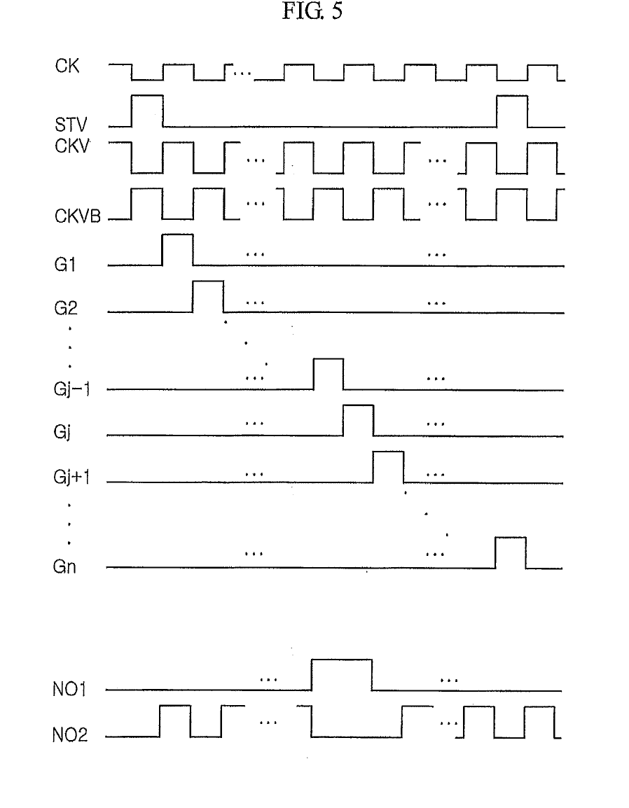

FIG. 3 is a block diagram illustrating the display apparatus according the first embodiment of the present invention. FIG. 4 is a circuit diagram illustrating stages according to the first embodiment. FIG. 5 is a waveform diagram illustrating the operation of the gate driver according to the first embodiment.

Referring to FIGS. 3 and 5, the gate driver 200 according to the embodiment includes first to n-th stages 200-1 to 200-n that are connected to the plurality of gate lines G1 to Gn, respectively. The first to n-th stages 200-1 to 200-n supply the gate turn-on signals Von or the gate turn-off signals Voff to the gate lines G1 to Gn, respectively, according to a plurality of operating signals that include the gate clock signal CKV, the inverted gate clock signal CKVB, the ground signal VSS, and the vertical synchronization start signal STV or output signals of the previous stages 200-1 to 200-n−1.

The first stage 200-1 is driven according to the vertical synchronization start signal STV, the gate clock signal CKV, the inverted gate clock signal CKVB, and the ground signal Vss, and supplies the gate turn-on signal Von to the first gate line G1. The second to n-th stages 200-1 to 200-n are driven according to the output signals (i.e., gate turn-on signals Von) of the previous stages 200-1 to 200-n−1, the gate clock signal CKV, the inverted gate clock signal CKVB, and the ground signal Vss, and supply the gate turn-on signals Von to the second and n-th gate lines G2 to Gn, respectively. The first to (n−1)th stages 200-1 to 200-n−1 are reset according to the output signals (i.e., gate turn-on signals Von) of the second to n-th stages 200-1 to 200-n, which are the next stages.

Preferably, each of the first to n-th stages 200-1 to 200-n has seven thin film transistors, as shown in FIG. 4. Hereinafter, a description will be given focusing on a j-th stage. The j-th stage 200-j includes a first transistor TR1, a second transistor TR2, a third transistor TR3, a fourth transistor TR4, a fifth transistor TR5, a sixth transistor TR6, a seventh transistor TR7, a first capacitor C1, and a second capacitor C2. The first transistor TR1 supplies the gate clock signal CKV of a gate clock signal input terminal to a signal output terminal according to a signal of a first node NO1. The second transistor TR2 supplies a (j−1)th signal Gj−1 of an output signal input terminal of a previous stage (i.e., a (j−1)th stage) to the first node NO1 according to the (j−1)th signal Gj−1 of the output signal input terminal of the (j−1)th stage. The third transistor TR3 supplies the signal of the first node NO1 to the ground voltage VSS according to a (j+1)th signal Gj+1 of an output signal input terminal of a next stage (i.e., a (j+1)th stage). The fourth transistor TR4 supplies the signal of the first node NO1 to the ground voltage VSS according to a signal of a second node NO2. The fifth transistor TR5 supplies a signal of a signal output terminal to the ground voltage VSS according to the signal of second node NO2. The sixth transistor TR6 supplies the signal of the signal output terminal to the ground voltage VSS according to the inverted gate clock signal CKVB of the inverted gate clock signal input terminal. The seventh transistor TR7 supplies the signal of the second node NO2 to the ground voltage VSS according to the signal of the first node NO1. The first capacitor C1 is provided between the first node NO1 and the signal output terminal. The second capacitor C2 is provided between the second node NO2 and the gate clock signal input terminal. The positions of the gate clock signal input terminal and the inverted gate clock signal input terminal may be changed to each other. The (j−1)th signal Gj−1 and the (j+1)th signal Gj+1 is a gate turn-on signal Von.

The operation of the above-described gate driver will now be described with reference to FIG. 5.

The gate driver 200 receives the gate clock signal CKV, the inverted gate clock signal CKVB, the ground signal VSS, and the vertical synchronization start signal STV. At this time, the gate driver 200 receives the gate clock signal CKV and the inverted gate clock signal CKVB from the gate clock generator 400. As shown in FIG. 5, the gate clock generator 400 generates the gate clock signal CKV and the inverted gate clock signal CKVB that have the same cycle as the internal clock signal CK and a pulse width corresponding to a voltage level of the gate turn-on voltage and the gate turn-off voltage.

The first stage 200-1 of the gate driver 200, which receives the signals, supplies the gate turn-on signal Von to the first gate line G1. The first stage 200-1 supplies the gate turn-on signal Von to the first gate line G1 during the logic high level of the gate clock signal CKV. Further, as described above, the second to n-th stages 200-1 to 200-n are driven according to the gate turn-on signal Von, the gate clock signal CKV, the inverted gate clock signal, and the ground signal, which are output signals of the previous stages 200-1 to 200-n−1, and supply the gate turn-on signals Von to the second to n-th gate lines G2 to Gn.

The operation of each of the stages will be described focusing on the operation of the j-th stage 200-j. When the (j−1)th signal Gj−1 at a logic high level, which is the output of the (j−1)th stage 200-j−1, is applied to the j-th stage 200-j, the second transistor TR2 is turned on. A node control signal at a logic high level is applied to the first node NO1 by the turned-on second transistor TR2. When the second transistor TR2 is turned on, the logic level of the node control signal of the first node NO1 is the same as that of the (j−1)th signal Gj−1.

At this time, according to the logic high level of the node control signal of the first node NO1, the seventh transistor TR7 is turned on. The signal of the second node NO2 is connected to the ground by the turned-on seventh transistor TR7, and the logic state of the second node NO2 becomes a logic low level. According to the signal at the logic low level in the second node NO2, the fourth and fifth transistors TR4 and TR5 are turned off.

Further, according to the node control signal at the logic high level in the first node NO1, the first transistor TR1 is turned on.

Then, when the gate clock signal CKV at the logic high level is applied, the gate turn-on signal Von at the logic high level is applied to the signal output terminal by the turned-on first transistor TR1. Thereby, the gate turn-on signal Von is applied to a gate line j. Further, when the inverted gate clock signal CKVB and the signal j+1 at the logic high level are applied, the third transistor TR3 and the sixth transistor TR6 are turned on. By the turned-on sixth transistor TR6, the signal of the signal output terminal is connected to the ground, and the logic state of the signal output terminal becomes a logic low level. By the turned-on third transistor TR3, the signal of the first node NO1 is connected to the ground and the logic state of the first node NO1 becomes a logic low level.

As such, in this embodiment, when the gate clock signal CKV at the logic high level is applied, the corresponding stage supplies the gate turn-on signal to the corresponding gate line. However, the above-described first to seventh transistors TR1 to TR7 are manufactured together with the thin film transistors T of the display panel 100. Therefore, the first to seventh transistors TR1 to TR7 use amorphous silicon as active layers. At this time, as described in FIG. 2, the output signal (i.e., gate turn-on signal Von) is delayed according to surrounding temperature.

The signal detector that detects a degree of delay of the gate turn-on signal and supplies a delay control signal, which is a result of delay detection, to the gate clock generator, will now be described.

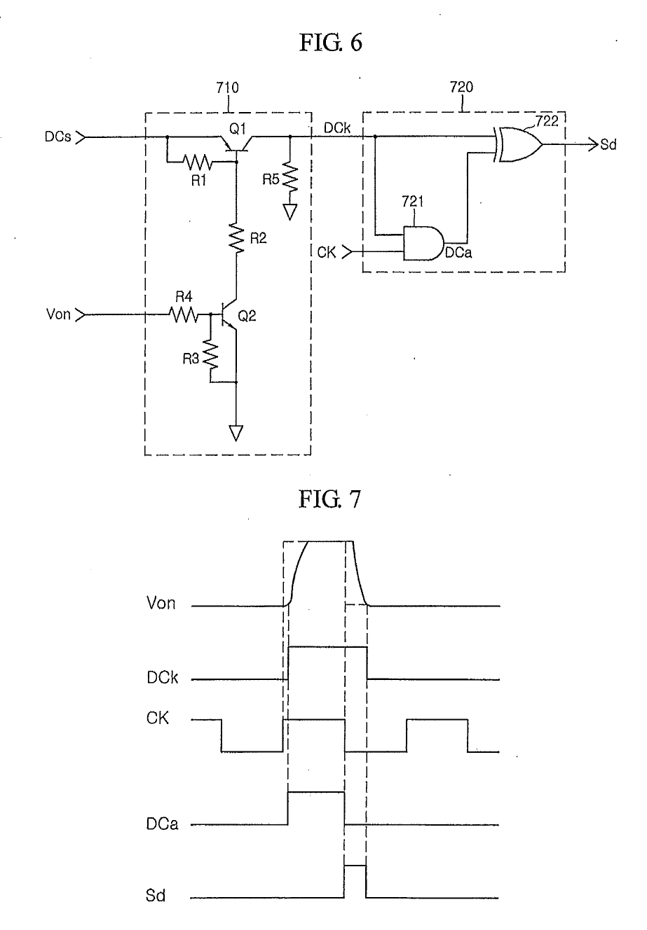

FIG. 6 is a circuit diagram illustrating the signal detector according to the first embodiment of the present invention. FIG. 7 is a waveform diagram illustrating the operation of the signal detector according to the first embodiment of the present invention.

Referring to FIG. 6, the signal detector 700 according to this embodiment includes a signal converter 710 that changes the amplitude of the output signal of the stage, and a signal inspecting unit 720 that inspects a degree of delay of a converting signal DCk of the signal converting unit 710 so as to generate a delay control signal Sd. Preferably, the signal converting unit 710 receives the output signals (i.e., gate turn-on signals Von and/or gate turn-off signals Voff) of the stages. Preferably, the signal detector 700 according to this embodiment receives the output signal of the first stage 200-1. However, the present invention is not limited thereto, and the signal detector 700 may receive an output signal of any one of the first to n-th stages 200-1 to 200-n. As shown in FIG. 1, preferably, the signal detector 700 is connected to the end that is on the opposite side of the gate line to which the output signal of the stage is applied. That is, the signal detector 700 uses as an input signal, the gate turn-on signal Von that is applied to the thin film transistor T farthest from the output of the stage. This is because the gate turn-on signal Von applied to the thin film transistor T located at the final end of the gate line is the most distorted signal.

The signal converting unit 710 includes a first driving transistor Q1 that has an emitter terminal connected to a direct current signal input terminal and a collector terminal connected to an output terminal of the signal converting unit 710, a first resistor R1 that is provided between a base terminal of the first driving transistor Q1 and the direct current signal input terminal, a second resistor R2 that has one end connected to the base terminal of the first driving transistor Q1, a second driving transistor Q2 that has an emitter terminal connected to a ground and a collector terminal connected to the second resistor R2, a third resistor R3 that is provided between a base terminal of the second driving transistor Q2 and the ground, and a fourth resistor R4 that is provided between the base terminal of the second driving transistor Q2 and the output signal input terminal of the stage 200-1.

The signal converting unit 710 further includes a fifth resistor R5 that is provided between the collector terminal of the first driving transistor Q1 and the ground. Preferably, the first driving transistor Q1 includes a PNP type transistor, and the second driving transistor Q2 includes an NPN type transistor. However, the present invention is not limited thereto. For each of the driving transistors, a bipolar junction transistor (BJT) is preferably used.

The signal converting unit 710 drops the amplitude of the output signal of the stage to a range of the amplitude in which the signal having the amplitude can be used in a general logic circuit, and outputs the signal having the dropped amplitude. Since the gate turn-on signal Von used in the stage uses a high voltage of 10 V or more, the gate turn-on signal Von is not appropriate when being used in the general logic circuit (which uses approximately 1 to 3 V). At this time, when the signal converting unit 710 receives the output signal of the first stage 200-1, the converting signal DCk at a logic high level is only output in an area of the first stage 200-1 where the gate turn-on signal Von is applied. That is, when a voltage between the base terminal and the emitter terminal of the second driving transistor Q2 is larger than a threshold voltage, the second driving transistor Q2 is turned on and the first driving transistor is driven. The signal converting unit 710 outputs the direct current signal DCs into the converting signal DCk. On the other hand, when the voltage between the base terminal and the emitter terminal of the second driving transistor Q2 is smaller than the threshold voltage, the second driving transistor Q2 does not operate. The signal converting unit 710 outputs the ground signal as the converting signal DCk. As a result, as shown in FIG. 7, the signal converting unit 710 outputs the converting signal DCk at a logic low level when the output of the stage corresponds to the gate turn-off signal Voff, and the converting signal DCk at a logic high level when the output signal of the stage corresponds to the gate turn-on signal Von. That is, the signal converting unit 710 outputs the converting signal DCk that has a logic high period corresponding to the width of the gate turn-on signal Von. At this time, preferably, the peak amplitude of the logic high period of the gate turn-on signal Von is in a range of 5 to 30 V, and the peak amplitude of the logic high period of converting signal DCk is in a range of 1 to 5 V.

The signal inspecting unit 720 includes an AND gate 721 that has one input terminal connected to a converting signal input terminal and the other input terminal connected to an internal clock signal input terminal, and an exclusive OR gate 722 that has one input terminal connected to the converting signal input terminal, the other input terminal connected to an output terminal of the AND gate 721, and an output terminal thereof connected to an output terminal of the signal inspecting unit 720. The AND gate shown in FIG. 6 may be used as the AND gate 721. However, the present invention is not limited thereto, but various circuits and circuit elements that perform a logical product of the converting signal DCk and the internal clock signal CK by the AND gate 721 may be used. The exclusive OR gate shown in FIG. 6 may used as the exclusive OR gate 722. However, the present invention is not limited thereto, and various circuits and circuit elements that perform an exclusive logical sum of the output of the AND gate 721 and the converting signal DCk by the exclusive OR gate 722 may be used.

The signal inspecting unit 720 uses the internal clock signal CK having the same cycle but with different amplitude from the gate clock signal CKV and the converting signal DCk obtained by changing the amplitude level of the gate turn-on signal Von by the signal converting unit 710 so as to output the delay control signal Sd corresponding to the delayed width of the logic high period of the gate turn-on signal Von as shown in FIG. 7. Then, as shown in FIG. 7, the signal inspecting unit 720 generates a logical product signal DCa by performing the logical product of the internal clock signal CK and converting signal DCk. That is, the signal inspecting unit 720 generates the logical product signal DCa corresponding to a region, in which the logic high periods of the internal clock signal CK and converting signal DCk overlap each other, by performing the logical product. As a result, the part where the logic high period of the converting signal DCk is located inside the logic high period of the internal clock signal CK can be determined. This means that it is possible to determine the width of the logic high period that is not delayed in the gate turn-on signal Von. Then, the signal inspecting unit 720 performs the exclusive logical sum of the logical product signal DCa and the converting signal DCk so as to output the delay control signal Sd as shown in FIG. 7. That is, it can be determined which part of the logic high period of the converting signal DCk is located outside the logic high period of the internal clock signal by performing the exclusive logical sum. Thus it is possible to determine the width of the delayed logic high period in the gate turn-on signal Von.

As described above, the display apparatus according to this embodiment can determine the width of the delayed logic high period of the gate turn-on signals Von, which are supplied to the gate lines G1 to Gn, respectively, of the display panel 100 through the gate driver 200, by the signal detector 700. Further, the display apparatus according to this embodiment can prevent the delay of the gate turn-on signal Von by using the delay control signal Sd (i.e., width of the delayed logic high period of the gate turn-on signal Von) of the signal detector 700 so as to reduce the logic high period of each of the gate clock signal CKV and the inverted gate clock signal CKVB, which are supplied to the gate driver 200, by the delayed width.

The present invention is not limited to the above description. That is, the display apparatus according to an embodiment of the present invention can control the width of the gate clock signal and the inverted gate clock signal in units of frames. Hereinafter, a display apparatus according to a second embodiment of the present invention will be described. Description of the first embodiment will be omitted. The technique of the second embodiment can be applied to the first embodiment.

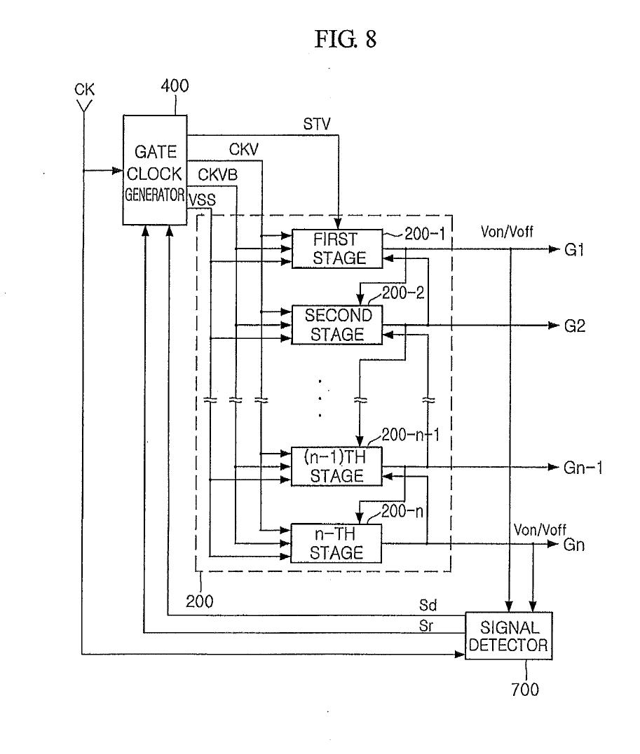

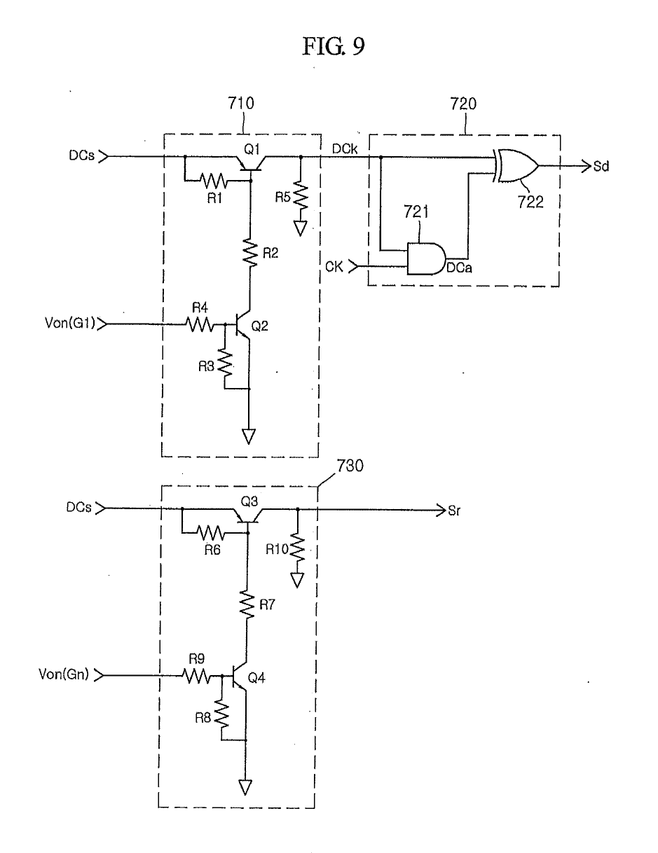

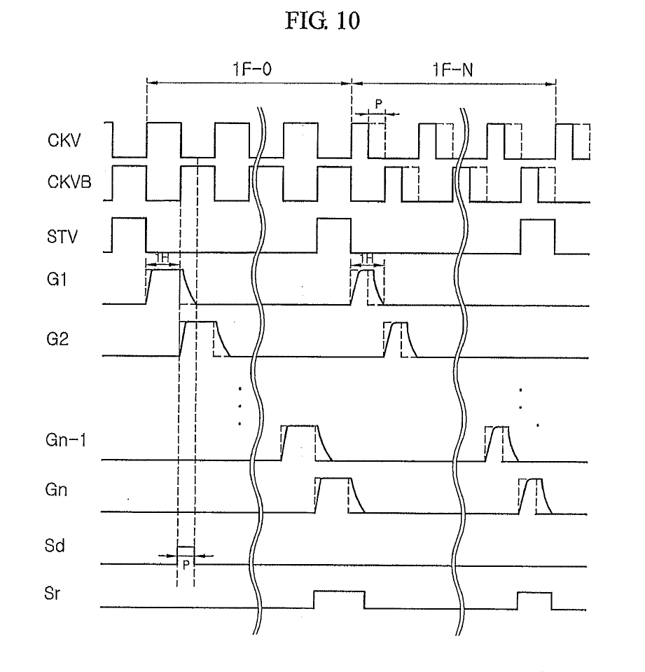

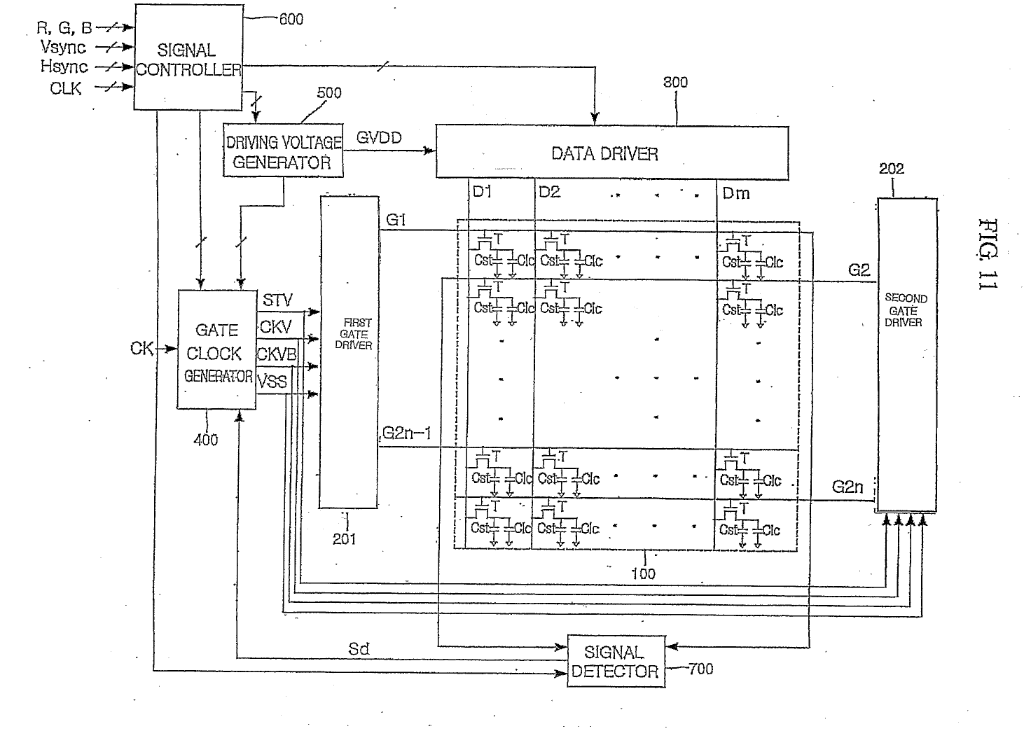

FIG. 8 is a block diagram illustrating a display apparatus according to a second embodiment of the present invention. FIG. 9 is a circuit diagram of a signal detector according to the second embodiment. FIG. 10 is a waveform diagram illustrating the operation of the display apparatus according to the second embodiment.

Referring to FIGS. 8 and 10, the display apparatus according to this embodiment detects whether a gate turn-on signal, which is an output of a stage, is delayed or not, controls the duty ratio of the gate clock signal and an inverted gate clock signal in units of frames according to the detection result, and supplies the gate clock signal and the inverted gate clock signal, whose duty ratio is controlled, to the display panel.

A signal detector 700 of the display apparatus outputs a delay control signal Sd according to the gate turn-on signal Von that is applied to a first gate line G1, and a reset signal Sr according to the gate turn-on signal Von that is applied to the n-th gate line Gn.

As shown in FIG. 9, the above-described signal detector 700 includes a signal converter 710 that outputs a converting signal DCk according to the gate turn-on signal Von of the first gate line G1, a signal inspecting unit 720 that compares an internal clock signal CK with the converting signal DCk so as to output a delay control signal Sd, and a reset signal output unit 730 that outputs the reset signal Sr according to the gate turn-on signal Von of the n-th gate line Gn. The signal converting unit 710 changes the amplitude of the gate turn-on signal Von of the first gate line G1. The reset signal output unit 730 changes the amplitude of the gate turn-on signal Von of the n-th gate line Gn. Since a circuit structure of the reset signal output unit 730 is similar to that of the signal converting unit 710, a description thereof will be omitted.

As such, the signal detector 700 does not output the delay control signal Sd when the gate turn-on signal Von that is applied to the first gate line G1 is not delayed, and the delay control signal Sd that has a pulse width as long as the delay width of the gate turn-on signal Von applied to the first gate line G1 when the gate turn-on signal Von is delayed.

The gate clock generator 400 generates the gate clock signal CKV and the inverted gate clock signal CKVB, each of which has the same cycle as the internal clock CK, when the delay control signal Sd is not applied, and supplies the gate clock signal CKV and the inverted gate clock signal CKVB to a plurality of stages 200-1 to 200-n of the gate driver 200. When the delay control signal Sd is applied, the gate clock generator 400 generates a new gate clock signal CKV and a new inverted gate clock signal CKVB obtained by reducing the logic high periods of the gate clock signal CKV and the inverted gate clock signal CKVB by the pulse width of the delay control signal. Then, the gate clock generator 400 supplies the new gate clock signal CKV and the new inverted gate clock signal CKVB to the plurality of stages 200-1 to 200-n of the gate driver 200 during a next frame period.

As shown in FIG. 10, the gate driver 200 uses the gate clock signal CKV and the inverted gate clock signal CKVB to supply the gate turn-on signal Von to the first gate line G1. When the gate turn-on signal Von applied to the first gate line G1 is delayed due to external (ambient) environment during the current frame period 1F-O, the signal detector generates the delay control signal Sd that has a pulse width as long as the delay width of the gate turn-on signal Von applied to the first gate line G1. Then, the signal detector supplies the generated delay control signal Sd to the gate clock generator 400. The gate clock generator 400 generates the new gate clock signal CKV and the new inverted gate clock signal CKVB, each of which has the changed pulse width of the logic high period thereof, according to the delay control signal Sd. As shown in FIG. 10, the gate clock generator 400 according to the second embodiment does not immediately apply the generated gate clock signal CKV and inverted gate clock signal CKVB during the current frame period 1F-O but applies and outputs the generated gate clock signal CKV and inverted gate clock signal CKVB during a next frame period 1F-N. The gate driver 200 uses the gate clock signal CKV and the inverted gate clock signal CKVB so as to sequentially supply the gate turn-on signals Von to the second to n-th gate lines G2 to Gn. Therefore, the gate driver 200 supplies a gate turn-on voltage Von to all of the gate lines during the current frame period 1F-O. Then, the gate driver 200 receives the new gate clock signal CKV and the new inverted gate clock signal CKVB, each of which has the changed pulse width, during the new frame period 1F-N. Then, the gate driver 200 sequentially supplies the gate turn-on signal Von to the first to n-th gate lines G1 to Gn. As a result, it is possible to compensate the delay of the gate turn-on signal Von during each frame.

Further, the signal detector 700 according to this embodiment uses the gate turn-on signal Von of the n-th gate line Gn so as to generate the reset signal Sr and supplies the generated reset signal Sr to the gate clock generator 400. An operation for the delay compensation of the gate clock generator 400 (i.e., control of the logic high periods of the gate clock signal CKV and the inverted gate clock signal CKVB) is reset in units of frames by the reset signal Sr that is supplied to the gate clock generator 400.

The display apparatus according to the embodiments of the present invention is not limited to the above description. The gate driver having the plurality of stages may be located at the edge of both sides of the display panel. Hereinafter, a display apparatus according to a third embodiment of the present invention will be described. An overlapping description of the description of the first and second embodiments will be omitted. A technique of the third embodiment can be applied to the first and second embodiments.

FIG. 11 is a block diagram of a display apparatus according to a third embodiment.

Referring to FIG. 11, the display apparatus according to this embodiment includes a display panel 100 that includes first to 2n-th gate lines G1 to G2n, a first gate driver 201 that is connected to odd-numbered gate lines G1 to G2n−1 of the display panel 100, a second gate driver 202 that is connected to even-numbered gate lines G2 to G2n of the display panel 100, and a signal detector 700 that receives a gate turn-on signal applied to the first gate line G1 through the first gate driver 201 and a gate turn-on signal applied to the second gate line G2 through the second gate driver 202. However, the present invention is not limited thereto. Each of the first and second drivers 201 and 202 may be connected to the first to 2n-th gate lines G1 to G2n.

The signal detector 700 supplies a delay control signal to the gate clock generator 400 according to whether the gate turn-on signal of the first gate line G1 and the gate turn-on signal of the second gate line G2 are delayed or not. Here, the first and second gate drives 201 and 202 operate according to a vertical synchronization start signal STV, a gate clock signal CKV, and an inverted gate clock signal CKVB of the gate clock generator 400. In FIG. 11, the first and second gate drivers 201 and 202 are controlled by the gate clock generator 400. However, the present invention is not limited thereto. The first and second gate drivers 201 and 202 may be controlled by two gate clock generators, respectively. Further, the signal detector may be divided into a first signal detector that detects a delay of the gate turn-on signal of the first gate line G1 and a second signal detector that detects a delay of the gate turn-on signal of the second gate line G2.

As described above, the display apparatus according to the embodiments of the present invention can compensate for the delay of the gate turn-on signals by the signal detector detecting whether the gate turn-on signals applied to the gate lines are delayed or not, and controlling the pulse width of the logic high period of the clock signal according to the detection result.

Further, the display apparatus according to the embodiments of the present invention can supply the gate turn-on signals to the gate lines for one horizontal clock cycle 1H by comparing the clock signal with the delayed gate turn-on signals so as to detect the delay width of the gate turn-on signals, and reducing the pulse width of the gate turn-on signals as much as the delay width.

Furthermore, the display apparatus according to the embodiments of the present invention can prevent distortion of the gate turn-on signals according to the external environment and prevent the erroneous operation of the display panel that occurs due to the distortion of the gate turn-on signals.

Although the invention has been described with reference to the accompanying drawings and the preferred embodiments, the invention is not limited thereto, but is defined by the appended claims. Therefore, it should be noted that various changes and modifications can be made by those skilled in the art without departing from the technical spirit of the appended claims.

What is claimed is:

1. A display apparatus comprising:
a display panel that includes a plurality of gate lines connected to a plurality of pixels;
a gate driver that sequentially supplies gate turn-on signals to the plurality of gate lines according to a driving clock signal;
a gate clock generator that generates the driving clock signal according to an internal clock signal and a delay control signal; and
a signal detector that generates the delay control signal according to the internal clock signal and the gate turn-on signal.

2. The display apparatus of claim 1, wherein the width of a logic high period of the internal clock signal is one horizontal clock cycle 1H.

3. The display apparatus of claim 2, wherein the pulse width of the delay control signal is the same as the delay width of the gate turn-on signal deviating the one horizontal clock cycle 1H.

4. The display apparatus of claim 1, wherein the gate clock generator reduces the width of the logic high period of the driving clock signal by the pulse width of the delay control signal.

5. The display apparatus of claim 1, wherein the gate clock generator changes the width of the logic high period of the driving clock signal according to the delay control signal supplied during a previous frame period and supplies the driving clock signal, whose width of the logic high period has been changed, to the gate driver during the current frame period.

6. The display apparatus of claim 5, wherein the signal detector further generates a reset signal that resets the operation of the gate clock generator that changes the width of the logic high period of the driving clock signal.

7. The display apparatus of claim 6, wherein the signal detector generates the delay control signal according to a gate turn-on signal that is supplied to the first gate line, and generates the reset signal according to a gate turn-on signal that is supplied to the final gate line.

8. The display apparatus of claim 1, wherein the signal detector includes:
a signal converter that outputs a converting signal according to at least one gate turn-on signal that are applied to the plurality of gate lines, respectively; and
a signal inspecting unit that compares the internal clock signal with the converting signal so as to output a delay control signal.

9. The display apparatus of claim 8, wherein the signal converting unit includes:
a first driving transistor that has an emitter terminal connected to a direct current signal input terminal and a collector terminal connected to a converting signal output terminal;
a first resistor connected between a base terminal of the first driving transistor and the direct current signal input terminal;
a second resistor connected to the base terminal of the first driving transistor;
a second driving transistor having an emitter terminal connected to a ground and a collector terminal connected to the second resistor;
a third resistor that connected between a base terminal of the second driving transistor and ground;
a fourth resistor connected between the base terminal of the second driving transistor and the gate turn-on signal input terminal; and
a fifth resistor connected between the collector terminal of the first driving transistor and ground.

10. The display apparatus of claim 8, wherein the signal inspecting unit includes:
a logical product signal generating unit that generates a logical product signal by performing a logical product of the converting signal and the internal clock signal; and
a delay control signal generating unit that generates a delay control signal by performing an exclusive logical sum of the logical product signal and the converting signal.

11. The display apparatus of claim 10, wherein an AND gate is used as the logical product signal generating unit and an exclusive OR gate is used as the delay control signal generating unit.

12. The display apparatus of claim 8, wherein the converting signal has the same cycle but a different amplitude from the gate turn-on signal.

13. The display apparatus of claim 8, wherein the peak amplitude of the logic high period of the gate turn-on signal is in the range of 5 to 30 V, and the peak amplitude of the logic high period of the converting signal is in the range of 1 to 5 V.

14. The display apparatus of claim 1, wherein the display panel includes a lower substrate that has a plurality of gate lines extending in one direction and an upper substrate that is disposed on the lower substrate, and the gate driver is formed at the edge of one side of the lower substrate and includes a plurality of stages connected to the plurality of gate lines, respectively.

15. The display apparatus of claim 1, wherein the display panel includes a lower substrate that has a plurality of gate lines extending in one direction and an upper substrate that is disposed on the lower substrate, and the gate driver includes first and second gate drivers that are formed at the edge of both sides of the lower substrate while the first gate driver is connected to odd-numbered gate lines and the second gate driver is connected to even-numbered gate lines.

16. The display apparatus of claim 1, wherein the internal clock signal is generated using a dot clock signal that has a higher frequency than the internal clock signal, and the gate clock generator detects the pulse width of the delay control signal by using the dot clock signal.

17. The display apparatus of claim 1, wherein the driving clock signal includes a gate clock signal and an inverted gate clock signal.

18. A method of driving a display apparatus, the method comprising:
generating a driving clock signal by using an internal clock signal;
generating gate turn-on signals according to the driving clock signal;
supplying the gate turn-on signals to gate lines, respectively;
generating a delay control signal that has a pulse width as long as the delay width of the gate turn-on signal after the gate turn-on signal is delayed; and
reducing the pulse width of the logic high period of the driving clock signal as much as the pulse width of the delay control signal.

19. The method of claim 18, wherein the generating of the delay control signal includes:
generating a converting signal that has the same cycle as the gate turn-on signal and a low voltage level of the peak amplitude;
generating a logical product signal by performing a logical product of the converting signal and the internal clock signal; and
generating the delay control signal by performing an exclusive logical sum of the logical product signal and the converting signal.
